(19) United States
(12) Patent Application Publication
(10) Pub. No.: US 2015/0281585 A1
(43) Pub. Date: Oct. 1, 2015

(54) Apparatus Responsive To At Least Zoom-In User Input, A Method And A Computer Program

(71) Applicant: Nokia Corporation, Espoo (FI)

(72) Inventor: Olcay Guldogan, Tampere (FI)

(21) Appl. No.: 14/372,130

(22) PCT Filed: Dec. 6, 2012
(86) PCT No.: PCT/IB2012/057016

§ 371 Date: Jul. 14, 2014

(51) Int. Cl. H04N 5/232; G06F 3/0488

(52) U.S. Cl. CPC H04N 5/23296; H04N 5/23216; H04N 5/23293; G06F 3/04883

(57) ABSTRACT

An apparatus comprising: a camera; a camera viewfinder comprising a display configured to display an image in a display area; wherein the apparatus is configured, in response to a zoom-in user input, to control the display to display an image in the display area and decrease a demarcated frame area within the display area relative to the display area, and in response to a selection event, to control a portion of the image within the frame area at that time to be re-sized to occupy the display area.

### TECHNOLOGICAL FIELD

Embodiments of the present invention relate to an apparatus responsive to at least zoom-in user input, a method and a computer program.

### BACKGROUND

An apparatus with camera functionality often has a zoom-in facility and a zoom-out facility which determine a magnification at which an image is captured. Zoom-in and zoom-out may be achieved optically using lenses and/or digitally using high resolution sensors.

However, it can be difficult for a user to effectively use the zoom-in and zoom-out facilities.

### BRIEF SUMMARY

According to various, but not necessarily all, embodiments of the invention there is provided an apparatus comprising: a camera; a camera viewfinder comprising a display configured to display an image in a display area;

wherein the apparatus is configured, in response to a zoom-in user input, to control the display to display an image in the display area and decrease a demarcated frame area within the display area relative to the display area, and in response to a selection event, to control a portion of the image within the frame area at that time to be re-sized to occupy the display area.

According to various, but not necessarily all, embodiments of the invention there is provided a method comprising: in response to a zoom-in user input, controlling a viewfinder displaying an image in a display area to decrease a demarcated frame area within the display area relative to the display area; and in response to a selection event, controlling a portion of the image within the demarcated frame area at that time to be re-sized to occupy the display area.

According to various, but not necessarily all, embodiments of the invention there is provided an apparatus comprising: at least one processor; and at least one memory including computer program code the at least one memory and the computer program code configured to, with the at least one processor, cause the apparatus at least to perform in response to a zoom-in user input, controlling a viewfinder displaying an image in a display area to decrease a demarcated frame area within the display area relative to the display area; and in response to a selection event, controlling a portion of the image within the demarcated frame area at that time to be re-sized to occupy the display area.

According to various, but not necessarily all, embodiments of the invention there is provided an apparatus comprising: means for controlling, in response to a zoom-in user input, a viewfinder displaying an image in a display area to decrease a demarcated frame area within the display area relative to the display area; and means for controlling, in response to a selection event, a portion of the image within the demarcated frame area at that time to be re-sized to occupy the display area.

According to various, but not necessarily all, embodiments of the invention there is provided an apparatus comprising: a camera; a camera viewfinder comprising a display configured to display an image in a display area;

wherein the apparatus is configured, in response to a zoom-in user input, to control the display to display an image in the display area and decrease a demarcated frame area within the display area relative to the display area, and in response to a selection event, to control capture and separate storage in a permanent memory of both the image within the frame area at that time and the image within the display area at that time.

Some embodiments of the present invention are therefore able to determine a consequence of a zoom-in operation before that zoom-in operation is actuated. This gives a user increased control. It may be particularly useful if a user is shooting video.

Some embodiments of the present invention may be able to determine a consequence of a zoom-out operation before that zoom-our operation is actuated. This gives a user increased control. It may be particularly useful if a user is shooting video.

### BRIEF DESCRIPTION

For a better understanding of various examples of embodiments of the present invention reference will now be made by way of example only to the accompanying drawings in which:

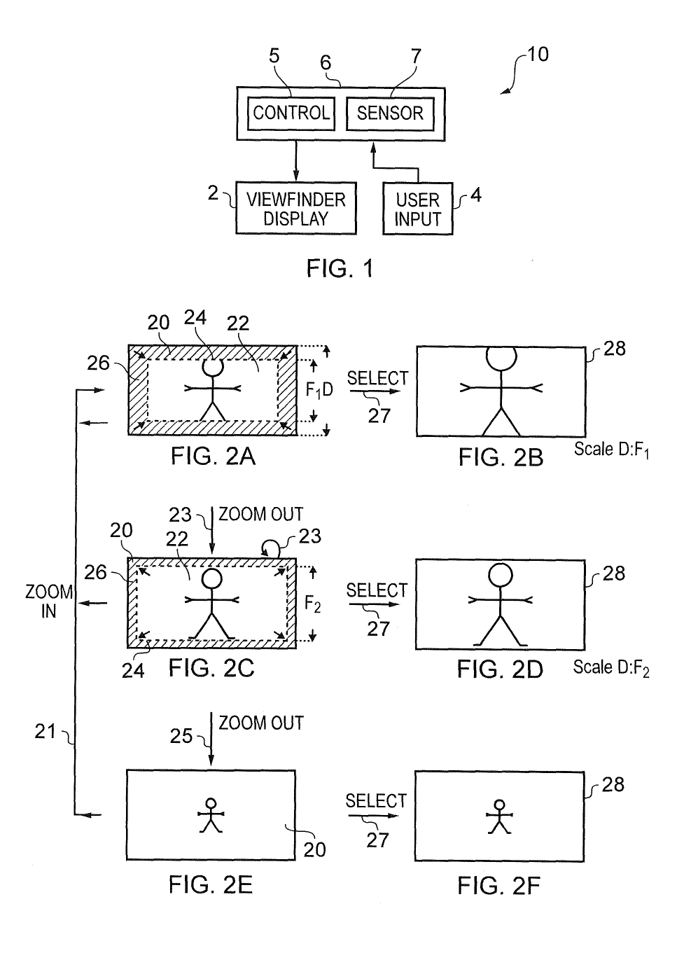

FIG. 1 schematically illustrates an apparatus;

FIGS. 2A to 2F illustrate different ways in which an image at a desired magnification can be obtained by controlled zooming-in and zooming-out;

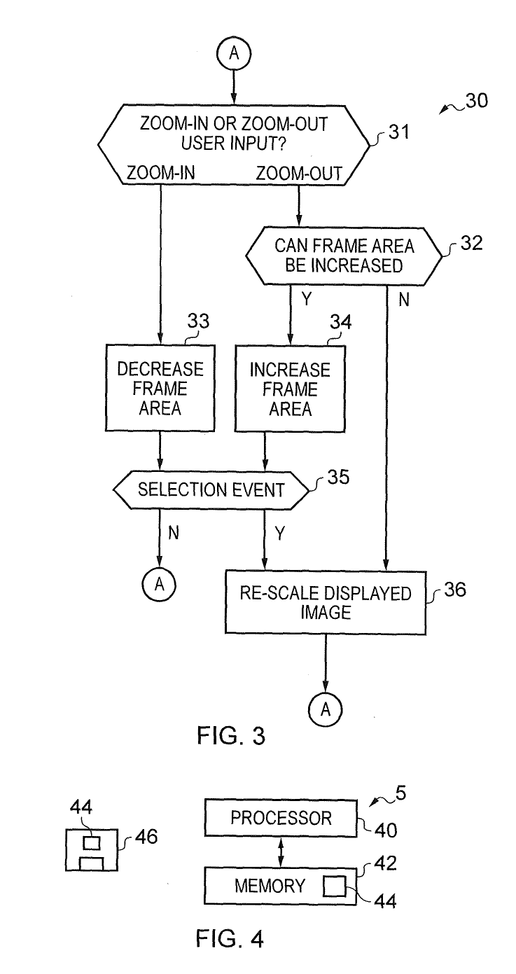

FIG. 3 schematically illustrates a method of controlled zooming-in and/or zooming-out;

FIG. 4 schematically illustrates an example of a controller;

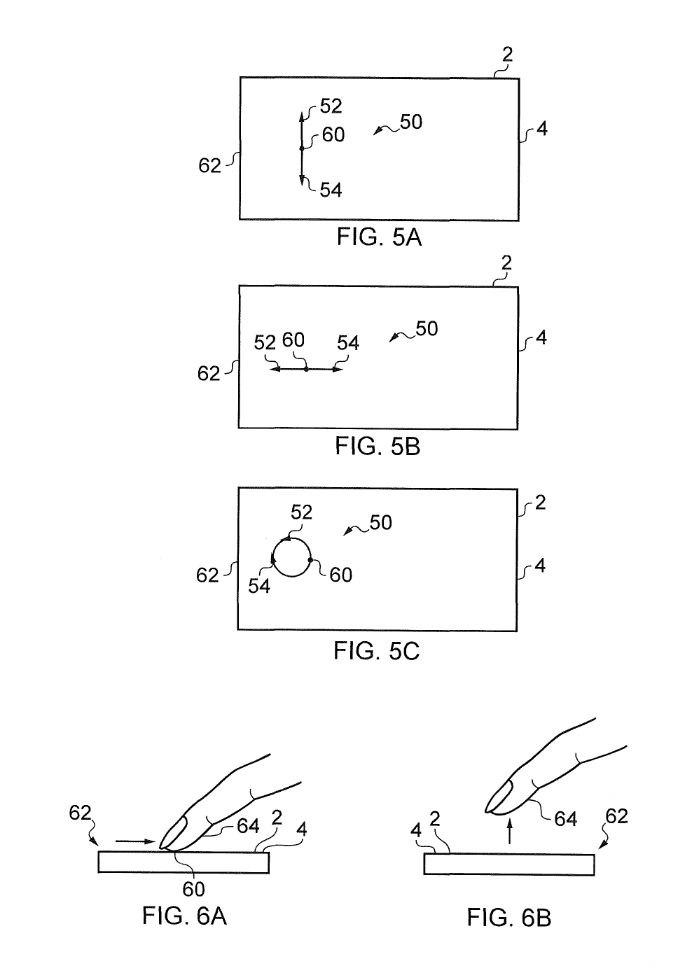

FIGS. 5A to 5C illustrate pairs of gestures for zoom-in user input and zoom-out user input;

FIG. 6A illustrates an object contacting a touch sensitive display during a touch gesture and FIG. 6B illustrates termination of the touch gesture by removing the object from contact with the touch sensitive display;

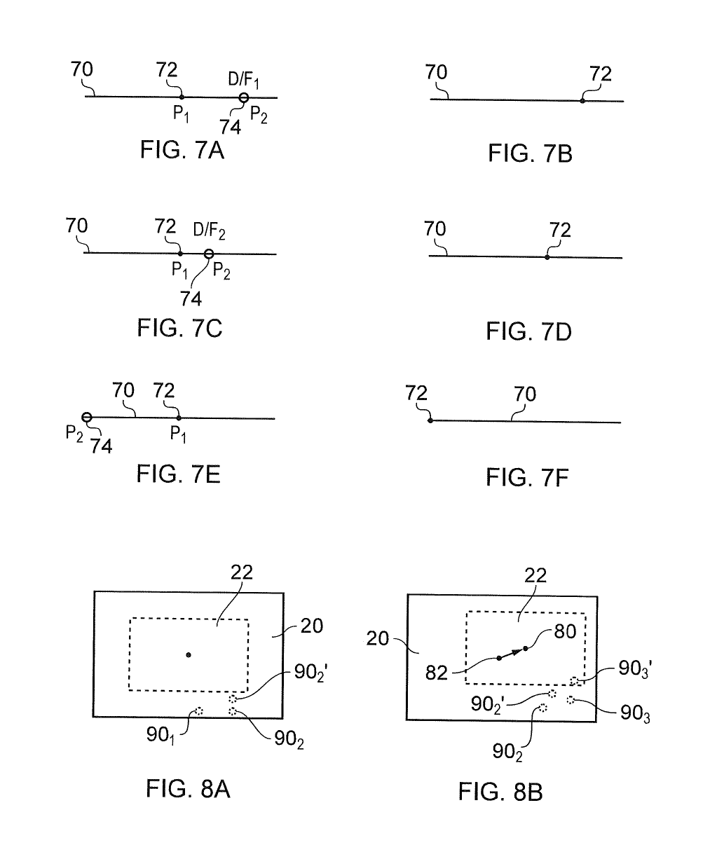

FIGS. 7A to 7F illustrate an example of an indicator for indicating a magnification; and

FIGS. 8A and 8B illustrate positioning a frame area within a display area.

### DETAILED DESCRIPTION

The Figures illustrate an apparatus 10 comprising: a camera 6; a camera viewfinder 2 comprising a display configured to display an image in a display area 20; wherein the apparatus 10 is configured, in response to a zoom-in user input 21, to control the display 2 to display an image in the display area 20 and decrease a demarcated frame area 24 within the display area 20 relative to the display area 20, and in response to a selection event 27, to control a portion of the image within the frame area 24 at that time to be re-sized to occupy the display area 20.

FIG. 1 schematically illustrates an apparatus 10 comprising: a camera 6; a camera viewfinder 2 comprising a display configured to display an image in a display area 20, and a user input device 4 enabling a user to provide commands to the apparatus 2.

In the illustrated example, for the sake of clarity, the viewfinder display 2 and the user input 4 are illustrated as distinct, separate components. The viewfinder display 2 and the user input 4 may in some implementations be distinct, separate components. However, in other implementations, the viewfinder display 2 and the user input 4 may be integrated as a single component such as a touch sensitive display, for example.

In this example, the camera 6 comprises a sensor 7 for capturing an image and a controller 5 configured to control operation of the camera 6. In some implementations the controller 5 may be a separate component to the sensor 7 or the functionality of the controller 5 may be shared between a controller that is an integral part of the camera 6 and a separate controller, such as, for example a processor of the apparatus 10.

The sensor 7 captures an image and the image is displayed in the viewfinder display 2. The user, via the user input 4, is able to zoom-in or zoom-out on the displayed image in the viewfinder display 2.

Zoom-out means that the apparent angle of view subtended by the image increases assuming a fixed distance from the imaged object which is equivalent to the apparent distance from the imaged object increasing assuming a fixed angle of view.

Zoom-in means that the apparent angle of view subtended by the image decreases assuming a fixed location which is equivalent to the apparent distance from the imaged object decreasing assuming a fixed angle of view.

In some implementations of a stills camera, when the user has an image at the correct magnification (zoom), the user can control the camera to permanently capture the temporary image in the viewfinder. The image is then stored to a non-volatile memory where it remains until deleted or removed by user action.

In some implementations of a video camera, the image in the viewfinder may automatically be permanently captured. A series of images is stored to a non-volatile memory where they remains until deleted or removed by user action.

As illustrated, for example, in FIGS. 2A to 2F, the apparatus 10 enables a new way of obtaining an image at a desired magnification by zooming-in and zooming-out.

The zoom-in and zoom-out may be achieved optically or digitally.

Referring to FIG. 2A the apparatus 2 controls the display 2 to display an image in the display area 20. In response to a zoom-in user input 21 the apparatus 2 creates a frame area 22 within the display area 20 and decreases a size of the demarcated frame area 22 relative to a size of the display area 20.

The frame area 22 overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

In response to further zoom-in user input 21, the apparatus 2 further decreases the size of the demarcated frame area 22 relative to a size of the display area 20.

The frame area 22 still overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

If the zoom-in user input 21 is terminated by a selection event 27, then the apparatus 2 controls the portion of the image within the frame area 22 at that time to be re-sized to occupy the display area 20 and displays the re-sized image (FIG. 2B).

The re-sizing of the image is in proportion to the ratio of the display area dimension D to the equivalent frame area dimension F1, that is, the image is scaled by D/F1.

If the zoom-in user input 21 is not terminated but changes to a zoom-out user input 23, the apparatus 2 increases the size of the demarcated frame area 22 relative to a size of the display area 20 (FIG. 2C).

The frame area 22 still overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

In response to further zoom-out user input 23, the apparatus 2 further increases the size of the demarcated frame area 22 relative to a size of the display area 20 (FIG. 2C).

The frame area 22 still overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

If the zoom-out user input 23 is terminated by a selection event 27, then the apparatus 2 controls the portion of the image within the frame area 22 at that time to be re-sized to occupy the display area 20 and displays the re-sized image (FIG. 2D).

The re-sizing of the image is in proportion to the ratio of the display area dimension D to the equivalent frame area dimension F2, that is, the image is scaled by D/F2.

If the zoom-out user input 23 is not terminated but is changed to a zoom-in user input 21, the apparatus 2 decreases the size of the demarcated frame area 22 relative to a size of the display area 20 (FIG. 2A).

The frame area 22 still overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

If, however, the zoom-out user input 23 is not terminated but a further zoom-out user input 23 is made, the apparatus 2 increases the size of the demarcated frame area 22 relative to a size of the display area 20 (FIG. 2C).

The frame area 22 still overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

The apparatus 2, in response to further zoom-out user input 23, increases the size of the demarcated frame area 22 relative to a size of the display area 20 until it becomes of equal size to the display area 20.

The frame area 22 cannot then be increased relative to the display area 20. The apparatus 2, in response to further zoom-out user input 25, no longer displays a demarcated frame area 22 within the display area 20 and increases the apparent angle of view of the displayed image (FIG. 2E).

For example, in FIG. 2C a first image is displayed with a first apparent angle of view in the display area 20. In response to a zoom-out user input 25, when a frame area 22 cannot be increased relative to the display area 20, then as illustrated in FIG. 2E a second image is displayed with a second apparent angle of view that is greater than the first apparent angle of view. The magnification of the displayed image does therefore change in response to zoom-out user input 25.

If the zoom-out user input 25 is then terminated by a selection event 27, then the apparatus 2 displays the current image on the display 20 (FIG. 2F).

If the zoom-out user input 25 is not terminated but is changed to a zoom-in user input 21, the apparatus 2 then creates a demarcated frame area 22 within the display area 20 and decreases the size of the demarcated frame area 22 relative to a size of the display area 20 (FIG. 2A).

The frame area 22 overlies the displayed image and a portion of the displayed image is visible within the frame area 24 and a portion of the displayed image is visible outside the frame area 24. The magnification of the displayed image does not change as the frame area 22 changes. The frame area 22 illustrates to a user the image that would be obtained if a selection event 27 occurs.

It will therefore be appreciated that in this example image magnification does not occur when the demarcated frame area is present on the display. The demarcated frame area may be varied by a user. The demarcated frame area 22 indicates to a user what will be displayed or captured after a selection event 27.

In the above description, a zoom-in 21 is performed from an initial state. However, it would also be possible to perform a zoom-out 25 from the initial state. The initial state is at the transition point between frame area 22 creation and re-sizing and changing the apparent angle of view.

If the scaling of the image at the initial state is S, the re-sizing of the image on selection 27 is in proportion to the ratio of the display area dimension D to the equivalent frame area dimension F at the time of selection. That is, after selection the image has a scaling of S*D/F.

The selection event 27 may be a termination of a zoom-in user input 21 or a zoom-out user input. Termination in this sense means that the user input is stopped rather than changed. Termination may, for example, occur when a touch point 60 on a touch sensitive screen 62 used for zoom-in/zoom-out (FIG. 6A) is removed from the touch sensitive screen 62 (FIG. 6B).

The frame area 22 may be demarcated by some visual attributes such as a boundary 24. Additionally or alternatively, the image displayed in the display area 20 (excluding the frame area 22) and the image portion displayed in the frame area have, in the illustrated example, different visual characteristics such as different brightness provide demarcation.

The demarcated frame area 22 has an aspect ratio that is the same as an aspect ratio of the display area 20 but has pixel dimensions (length and width) that vary with a zoom-in user input 21 and a zoom-out user input 23.

The image displayed in the display area 20 and the image portion displayed in the demarcated frame area 22 have the same magnification scale (the same apparent angle of view)

Referring to FIGS. 5A to 5C, the apparatus 2 may be configured to detect a first gesture 52 as a zoom-in user input and a second different gesture 54 as a zoom-out user input. The first gesture 52 and the second gesture 54 form a pair 50 of associated gestures of opposite sense.

The first touch gesture and/or the second touch gesture may, in this example, be initiated at any position on the touch sensitive display 62.

In FIG. 5A, the first gesture 52 comprises a movement upwards that is characterised by a vector component in a first sense (upwards) and the second gesture 54 comprises a movement downwards that is characterised by a vector component in a second sense (downwards) that is opposite to the first sense.

In FIG. 5B, the first gesture 52 comprises a movement left that is characterised by a vector component in a first sense (left) and the second gesture 54 comprises a movement right that is characterised by a vector component in a second sense (right) that is opposite to the first sense.

In FIG. 5C, the first gesture 52 is comprises a counter-clockwise movement that characterised by a vector component in a first sense (curl out of page) and the second gesture 54 comprises a clockwise movement that is characterised by a vector component in a second sense (curl into page) that is opposite to the first sense.

The viewfinder display 2 may be a touch sensitive display 62 configured to detect a first touch gesture 52 as a zoom-in user input and a second different touch gesture 54 as a zoom-out user input. The first touch gesture 52 may consist of a tracing movement of a single touch point 60 and the second touch gesture may consist of a tracing movement of a single touch point 60. A touch point 60 is a point of contact or touch between the object, for example the finger or stylus, used for to make the touch gesture and the touch sensitive display 62.

In FIGS. 5A and 5B, the first touch gesture 52 involves a single trace on the touch sensitive display 62 with a component in a first direction and the second touch gesture 54 involves a single trace on the touch sensitive display 62 with a component in a second direction opposite to the first direction.

FIG. 6A illustrates an object 64 (a finger) that contacts the touch sensitive display 62 at a touch point. Movement of the object 64 while in contact with the touch sensitive display creates a touch gesture 52, 54.

FIG. 6B illustrates termination of the touch gesture by removing the object 64 from contacts with the touch sensitive display 62. Termination of the touch gesture may be a selection event 27.

Thus, in response to a trace made by a user's touch input extending in a first direction, the apparatus 2 controls the viewfinder 2 to decrease a demarcated frame area 22 within the display area 20 relative to the display area 20. In response to the trace made by the user's touch input changing direction and extending in a second direction opposite to the first direction, the apparatus 2 controls the viewfinder 2 to increase the demarcated frame area 22 within the display 20 area relative to the display area 20. In response to the trace made by the user's touch input being terminated by a removal of an object 64 in contact with a touch sensitive screen 62 from contact with the touch sensitive screen 62, the apparatus 2 controls a portion of the image within the demarcated frame area 22 at that time to be re-sized to occupy the display area 20.

The apparatus 2 may be configured to perform a different one of a plurality of re-sizing operations in response to a selection event 27. The re-sizing operation re-sizes the image within the frame area 22 to occupy the display area 20. One resizing operation may instantaneously re-size the image within the frame area 22 to occupy the display area 20. Another resizing operation may re-size the image as a series of transitions. For example, the image within the frame area 22 may be gradually resized over a number of frames to occupy the display area 20.

Which type of resizing operation is used may be made dependent upon the type of zoom-in/zoom-out user input immediately preceding the selection event 27.

For example, it may be that the pair 50 of user inputs 52, 54 of each of FIGS. 5A, 5B, 5C is associated with a different re-sizing operation. Thus if the selection event 27 occurs on terminating a user input 52, 54 as illustrated in FIG. 5A then a first re-sizing operation may occur whereas if the selection event 27 occurs on terminating a user input 52, 54 as illustrated in FIG. 5B or 5C then a different re-sizing operation occurs.

In some implementations, the selection event 27 may additionally trigger automatic image capture and storage in a permanent memory of the re-sized image.

In some implementations, the selection event 27 may trigger capture and separate storage in a permanent memory of both the image within the frame area 22 at that time and the image within the display area 20 at that time.

In some implementations, the selection event 27 does not automatically cause image capture and a separate user actuation is required to capture and store in a permanent memory of the re-sized image.

The camera 6 may be a stills camera and/or a video camera.

FIG. 3 schematically illustrates a method 30.

At block 31 it is determined whether a user input is a zoom-in user input or a zoom-out user input.

If the user input is a zoom-in user input the method moves to block 33. At block 33 the frame area 22 is decreased in size and the method moves to block 35. At block 35, if a selection event 27 is not detected the method returns to block 31 (indicated using A). If a selection event is detected, the method moves to block 36 where the portion of the image within the frame area 24 at the time of the selection event 27 is re-sized to occupy the display area 20. The method then returns to block 31.

If the user input is a zoom-out user input the method moves from block 31 to block 32. At block 32 it is determined whether a frame area exists and can be further increased, if this is the case the method moves to block 34 and if it is not the case the method moves to block 36 where the displayed image is re-scaled to increase its apparent angle of view.

At block 34, the frame area 22 is increased in size and the method moves to block 35. At block 35, if a selection event 27 is not detected the method returns to block 31. If a selection event is detected, the method moves to block 36 where the portion of the image within the frame area 24 at the time of the selection event 27 is re-sized to occupy the display area 20. The method then returns to block 31 (indicated using A).

FIG. 4 schematically illustrates an example of a controller 5 or a controller used to augment the controller 5.

Implementation of controller can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

In FIG. 4, a processor 40 is configured to read from and write to the memory 42. The processor 40 may also comprise an output interface via which data and/or commands are output by the processor 40 and an input interface via which data and/or commands are input to the processor 40.

The memory 42 stores a computer program 44 comprising computer program instructions that control the operation of the apparatus 10 when loaded into the processor 40. The computer program instructions 44 provide the logic and routines that enables the apparatus to perform the methods illustrated in FIGS. 2A to 2F, FIG. 3, FIGS. 5A to 5C and FIGS. 6A and 6B. The processor 40 by reading the memory 42 is able to load and execute the computer program 44.

Consequently, the apparatus 10 may therefore comprise: at least one processor 40; and at least one memory 42 including computer program code 44 the at least one memory 42 and the computer program code 44 configured to, with the at least one processor 40, cause the apparatus 10 at least to perform: in response to a zoom-in user input 21, controlling a viewfinder displaying an image in a display area 20 to decrease a demarcated frame area 22 within the display area 20 relative to the display area 20; and in response to a selection event 27, controlling a portion of the image within the demarcated frame area 22 at that time to be re-sized to occupy the display area 20.

The computer program may arrive at the apparatus 10 via any suitable delivery mechanism 46. The delivery mechanism 46 may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 44. The delivery mechanism may be a signal configured to reliably transfer the computer program 44. The apparatus 10 may propagate or transmit the computer program 44 as a computer data signal.

Although the memory 42 is illustrated as a single component it may be implemented as one or more separate components some or all of which may be integrated/removable and/or may provide permanent/semi-permanent/ dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

As used here ‘module’ refers to a unit or apparatus that excludes certain parts/components that would be added by an end manufacturer or a user. The apparatus 10 may be a camera module, for example, comprising a camera 6 and a touch sensitive viewfinder.

As illustrated in FIGS. 7A to 7F, an indicator 70 may be displayed within the display area 20 that illustrates graphically and/or numerically the original magnification of the displayed image and the magnification that would be obtained after selection. The indicator 70 may, for example, be a slider with a first widget 72 indicating an initial magnification S of the image in the display area when zoom-in user input was initiated and a second different sliding widget 74 indicating a putative magnification to be applied with the current zoom-in/zoom-out in response to a selection event.

The FIGS. 7A to 7F illustrate an example of an indicator 70. Each of FIGS. 7A to 7F illustrates a configuration of the indicator 70 for each of respective FIGS. 2A to 2F.

Referring to FIGS. 7A to 7D, whenever a zoom-in function starts, the currently displayed image and its magnification (S) may set the position p1 of the first widget 72 within the slider 70. As the frame area 22 is decreased/increased, the second widget 74 moves relative to the first widget 72. The position p2 of the second widget 74 is S scaled by the ratio of the display area dimension D to the equivalent frame area dimension F, that is, the position is S*D/F. The position p2 of the second widget 74 is indicative of a putative magnification to be applied to a portion of the image within the demarcated frame area 22 in response to a selection event such that the portion of the image within the frame area 22 is re-sized to occupy the display area 20. When selection occurs, the second widget 74 at the position equivalent to S*D/F becomes the first widget 72 for further zoom-in/zoom-out (FIGS. 7B and 7D).

Referring to FIGS. 7E and 7F, whenever a zoom-out function starts, the currently displayed image and its magnification (S) may set the position p1 of the first widget 72 within the slider. As the frame area is decreased/increased, the second widget 74 moves relative to the first widget 72. The position p2 of the second widget 74 is S scaled by the scaling of the displayed image. When selection occurs, the second widget 74 becomes the first widget 72 for further zoom-in/zoom-out (FIG. 7F).

The blocks illustrated in the FIG. 3 may represent steps in a method and/or sections of code in the computer program [ref]. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

As illustrated in FIGS. 2A and 2B, normally when a zoom-in/zoom-out occurs the centre of the frame area 22 and the centre of the display area 20 are coincident and remain coincident. However, in some embodiments, for example as illustrated in FIGS. 8A and 8B, it may be possible to position and re-position the frame area 22 within the display area 20. That is it may be possible to use a displacement user input to displace a centre 80 of the frame area 22 with respect to a centre 82 of the display area 20.

As an example, zoom-in and zoom-out may be effected by touch input 60 using a single point of contact (e.g., a single digit) as illustrated in FIGS. 5A-5C and 6A and 6B. Movement of the single point of contact 60 from a position 90₁ to a position 90₂ causes a zoom-in and a reduction of the frame area 22.

Re-positioning of the frame area 22 may be effected by creating a second point of contact (e.g. by touching a second digit to the touch sensitive display 62) at point 90′₂ and moving both of the points of contacts together to new positions 90₃ and 90′₃ The frame area 22 is displaced in the same amount as a notional centre point between the first and second points of contact has been displaced. When the frame area 22 has been re-positioned as desired, the second point of contact is removed leaving the first point of contact at position 90₃ which may be moved to continue zoom-in and zoom-out.

Thus the displacement user input can be performed after a zoom-in user input or a zoom-out user input without performing an intermediate selection event and can be performed before a zoom-in user input or a zoom-out user input without performing an intermediate selection event. This provides for a continuity of positioning and sizing the frame area 22.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
at least one processor; and
at least one memory including computer program code
the at least one memory and the computer program code configured to, with the at least one processor, cause the apparatus at least to perform:
in response to a zoom-in user input, controlling a viewfinder displaying an image in a display area to decrease a demarcated frame area within the display area relative to the display area; and
in response to a selection event, controlling a portion of the image within the demarcated frame area at that time to be re-sized to occupy the display area.

2. An apparatus as claimed in claim 1, wherein the apparatus is configured, in response to a zoom-in user input, to control the display of an image in the display area and decrease a demarcated frame area within the display area relative to the display area, and, in response to a change in user input to a zoom-out user input, to control the display of an image in the display area and increase the demarcated frame area within the display area relative to the display area, and in response to a selection event, to control the image within the frame area at that time to be re-sized to occupy the display area.

3. An apparatus as claimed in claim 1, wherein the demarcated frame area has an aspect ratio that is the same as an aspect ratio of the display
area but has pixel dimensions that vary with a zoom-in user input and a zoom-out user input.

4. An apparatus as claimed in claim 1, wherein the apparatus is configured, to control display of a first image with a first apparent angle of view in the display area and in response to a zoom-out user input, when a frame area cannot be increased relative to the display area, to display in the display area a second image with a second apparent angle of view that is greater than the first apparent angle of view.

5.-6. (canceled)

7. An apparatus as claimed in any claim 1, wherein the apparatus is configured to detect a first gesture as a zoom-in user input and a second different gesture as a zoom-out user input.

8.-9. (canceled)

10. An apparatus as claimed in claim 7, wherein the camera viewfinder comprises a touch sensitive display configured to detect a first touch gesture as a zoom-in user input and a second different touch gesture as a zoom-out user input.

11. An apparatus as claimed in claim 10, wherein the first touch gesture involves movement of a single touch point and the second touch gesture involves movement of a single touch point.

12. An apparatus as claimed in claim 10, wherein termination of the single touch point is the selection event.

13. (canceled)

14. An apparatus as claimed in claim 10, wherein a touch gesture comprising a first touch gesture and/or a second touch gesture may be initiated at any position on the touch sensitive display.

15. An apparatus as claimed in claim 1, wherein termination of a zoom-in/zoom-out user input is the selection event.

16. (canceled)

17. An apparatus as claimed in claim 1, wherein the apparatus is configured to perform a different one of a plurality of re-sizing operations
in response to a selection event, for re-sizing the image within the frame area to occupy the display area wherein a re-sizing operation used is dependent upon which of a plurality of the zoom-in user inputs or zoom-out user inputs immediately precedes the selection event.

18.-19. (canceled)

20. An apparatus as claimed in claim 1, wherein the apparatus is configured such that the selection event triggers capture and separate storage in a permanent memory of both the image within the frame area at that time and the image within the display area at that time.

21. An apparatus as claimed in claim 1, wherein the apparatus is configured, in response to each zoom-in user input, to control display of an image in the display area and decrease a demarcated frame area within the display area relative to the display area, and in response to a selection event, to control a portion of the image within the frame area at that time to be re-sized to occupy the display area.

22. An apparatus as claimed in claim 1, wherein the apparatus is configured, in response to a zoom-in user input, to control display of an indicator indicative of a putative magnification to be applied to a portion of the image within the demarcated frame area in response to a selection event such that the portion of the image within the frame area is re-sized to occupy the display area.

23. (canceled)

24. An apparatus as claimed in claim 1, wherein the apparatus is configured, in response to a displacement user input, to displace a centre of the demarcated frame area within the display area relative to a centre of the display area.

25.-26. (canceled)

27. A method comprising:
in response to a zoom-in user input, controlling a viewfinder displaying an image in a display area to decrease a demarcated frame area within the display area relative to the display area; and
in response to a selection event, controlling a portion of the image within the demarcated frame area at that time to be re-sized to occupy the display area.

28. A method as claimed in claim 27, further comprising
before the selection event, in response to a zoom-out user input, controlling the viewfinder to increase a demarcated frame area within the display area relative to the display area.

29. A method as claimed in claim 27, further comprising
before the selection event, in response to a zoom-out user input, when a frame area cannot be increased relative to the display area, controlling the viewfinder to display in the display area the image with a greater apparent angle of view.

30. A method as claimed in claim 27, comprising:
controlling a viewfinder to display an image in a display area;
in response to a trace made by a user's touch input extending in a first direction, controlling the viewfinder to decrease a demarcated frame area within the display area relative to the display area;
in response to the trace made by the user's touch input changing direction and extending in a second direction opposite to the first direction, controlling the viewfinder to increase a demarcated frame area within the display area relative to the display area; and
in response to the trace made by the user's touch input being terminated by a removal of an object in contact with a touch sensitive screen from contact with the touch sensitive screen controlling a portion of the image within the demarcated frame area at that time to be re-sized to occupy the display area.

31.-37. (canceled)

38. An apparatus comprising:
a camera;
a camera viewfinder comprising a display configured to display an image in a display area;
wherein
the apparatus is configured, in response to a zoom-in user input, to control the display to display an image in the display area and decrease a demarcated frame area within the display area relative to the display area, and in response to a selection event, to control capture and separate storage in a permanent memory of both the image within the frame area at that time and the image within the display area at that time.
